(19) United States
(12) Patent Application Publication
(10) Pub. No.: US 2023/0403356 A1
(43) Pub. Date: Dec. 14, 2023

(54) SYSTEM AND METHOD FOR MANAGEMENT OF PLURALITY OF CALLS

(71) Applicant: BUZIBEE TECHNOLOGIES PRIVATE LIMITED, Cochin (IN)

(72) Inventors: Geejo George, Stony Brook, NY (US); Sanjay Chacko, Thane (IN)

(21) Appl. No.: 18/249,082

(22) PCT Filed: Oct. 13, 2021
(86) PCT No.: PCT/IB2021/059384

§ 371 Date: Apr. 14, 2023

(30) Foreign Application Priority Data
Oct. 16, 2020 (IN) 202041045038
Oct. 13, 2021 (WO) PCT/IB2021/059384

(51) Int. Cl. H04M 3/42; H04L 65/1096; H04L 65/1073; H04W 4/16

(52) U.S. Cl. CPC H04M 3/42374; H04L 65/1096; H04L 65/1073; H04M 3/42161; H04W 4/16

(57) ABSTRACT

A system and method for management of plurality of calls. The system also includes a user registration subsystem configured to register a user in the system based on one or more details and receive an input from the user representative of a plurality of rules defined by the user, a network configuration subsystem configured to identify an ongoing Internet Protocol call, change network configuration of an operator when the user is on the ongoing internet protocol call, identify whether the ongoing Internet Protocol call is disconnected and change the network configuration back to an original state, a notification subsystem configured to notify the user via one or more communication means if there are one or more calls which are received by the user during the ongoing Internet Protocol call and notify a caller about the ongoing Internet Protocol call.

### EARLIEST PRIORITY DATE

This Application claims priority from a Complete patent application filed in India having Patent Application No. 202041045038, filed on Oct. 16, 2020, and titled “SYSTEM AND METHOD FOR MANAGEMENT OF PLURALITY OF CALLS” and claims priority from a PCT patent application having Patent Application No. PCT/IB2021/059384, filed on Oct. 13, 2021, and titled “SYSTEM AND METHOD FOR MANAGEMENT OF PLURALITY OF CALLS”.

### FIELD OF INVENTION

Embodiments of a present disclosure relates to calls, and more particularly to, a system and a method for management of plurality of calls.

### BACKGROUND

Calls such as internet protocol calls and mobility calls are one of the most beneficial communication channels when it comes to customer service and communication services. Calls act as a connecting mean between people. Conventionally, all the mobility calls and the internet protocol calls work perfect in isolation but if a user gets the mobility call, during an ongoing internet protocol call in a device then the call management by the device is not seamless as either the mobility call intrudes the internet protocol call or the internet protocol call indication or response is not appropriate when the user in on the mobility call.

Traditionally, another system which is available sends a message to the caller when the caller is trying to reach a person and the mobile number of the called party is not reachable or the mobile number of the called party is switched off, or while the user is on another mobility call. Moreover, the system is only able to manage the mobility calls and is unable to provide a response associated with various internet protocol calls. Further, the called party will be informed via the message only when the mobile number of the called party is reachable again.

Hence, there is a need for system and a method for management of plurality of calls in order to address the aforementioned issues.

### BRIEF DESCRIPTION

In accordance with an embodiment of the disclosure, a system for management of plurality of calls is disclosed. The system includes one or more processors. The system also includes a user registration subsystem operable by the one or more processors. The user registration subsystem is configured to register a user in the system based on one or more details received from the user. The user registration subsystem is also configured to receive an input from the user representative of a plurality of rules defined by the user. The system also includes a network configuration subsystem communicatively coupled to the user registration subsystem and operable by the one or more processors. The network configuration subsystem is configured to identify an ongoing Internet Protocol call on the device of the user. The network configuration subsystem is also configured to change network configuration of an operator associated with the user in accordance with the plurality of the rules defined by the user, when the user is on the ongoing internet protocol call identified by the network configuration subsystem. The network configuration subsystem is configured to identify whether the ongoing Internet Protocol call is disconnected. The network configuration subsystem is also configured to change the network configuration back to an original state of the network after the ongoing internet protocol is disconnected.

The system also includes a notification subsystem communicatively coupled to the network configuration subsystem and operable by the one or more processors. The notification subsystem is configured to notify the user via one or more communication means in accordance with the plurality of rules defined by the user if there are one or more calls which are received by the user during the ongoing Internet Protocol call. The notification subsystem is also configured to notify a caller about the ongoing Internet Protocol call of the user via the one or more communication means.

In accordance with another embodiment of the disclosure, a method for management of plurality of calls is disclosed. The method includes registering a user in the system based on one or more details received from the user. The method includes receiving an input from the user representative of a plurality of rules defined by the user. The method includes identifying an ongoing Internet Protocol call on the device of the user. The method includes changing network configuration of an operator associated with the user in accordance with the plurality of the rules defined by the user, when the user is on the ongoing internet protocol call identified by the network configuration subsystem.

The method includes notifying the user via one or more communication means in accordance with the plurality of rules defined by the user if there are one or more calls which are received by the user during the ongoing Internet Protocol call. The method includes notifying a caller about the ongoing Internet Protocol call of the user via the one or more communication means. The method includes identifying whether the ongoing Internet Protocol call is disconnected. The method includes changing the network configuration back to an original state of the network after the ongoing internet protocol is disconnected.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram representation of a system for management of plurality of calls in accordance with an embodiment of the present disclosure;

FIG. 2 is a block diagram representation of a calendar integration subsystem of the system for management of plurality of calls FIG. 1 in accordance with an embodiment of the present disclosure;

FIG. 3 is a block diagram representation of a collaboration application providers integration subsystem of the system for management of plurality of calls FIG. 1 in accordance with an embodiment of the present disclosure;

FIG. 4 is an exemplary embodiment representing a block diagram of the system for management of plurality of calls FIG. 1 in accordance with an embodiment of the present disclosure;

FIG. 5 is a block diagram of management computer system or a server for plurality of calls in accordance with an embodiment of the present disclosure; and

FIG. 6A and FIG. 6B are flow diagrams representing steps involved in a method for management of plurality of calls in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprise”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and a method for management of plurality of calls. The system also includes a user registration configured to register a user in the system based on one or more details received from the user. The user registration subsystem is also configured to receive an input from the user representative of a plurality of rules defined by the user. The system also includes a network configuration subsystem configured to identify an ongoing Internet Protocol call on the device of the user. The network configuration subsystem is also configured to change network configuration of an operator associated with the user in accordance with the plurality of the rules defined by the user, when the user is on the ongoing internet protocol call identified by the network configuration subsystem. The network configuration subsystem is also configured to identify whether the ongoing Internet Protocol call is disconnected. The network configuration subsystem is further configured to change the network configuration back to an original state of the network after the ongoing internet protocol is disconnected. The system also includes a notification subsystem configured to notify the user via one or more communication means in accordance with the plurality of rules defined by the user if there are one or more calls which are received by the user during the ongoing Internet Protocol call. The notification subsystem is also configured to notify a caller about the ongoing Internet Protocol call of the user via the one or more communication means.

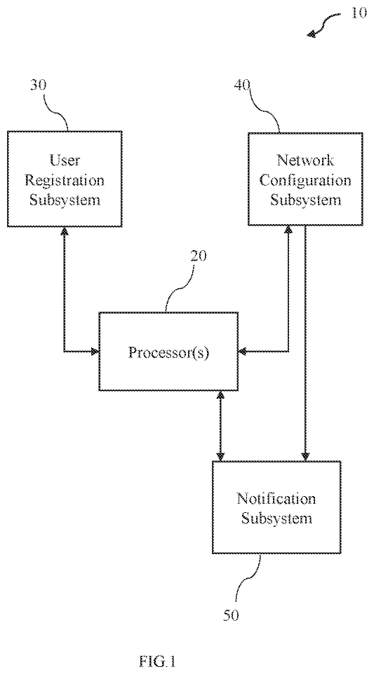

FIG. 1 is a block diagram representation of a system 10 for management of plurality of calls in accordance with an embodiment of the present disclosure. In one embodiment, the system 10 may include a web application, mobile application, a software development kit (SDK) and the like. The system 10 is hosted in a server. In such an embodiment, the server may include a cloud server. In one specific embodiment, the plurality of calls may include, but not limited to, one or more internet protocol (IP) calls and one or more mobility calls. In an exemplary embodiment, the one or more mobility calls may include GSM calls, CDMA calls, VoLTE Calls, and TDM calls. In one embodiment, the system 10 may be integrated within the servers of one or more cellular service providers. In another embodiment, the one or more users may download the application in a device associated with the user. In such embodiment, the incoming of the user may be routed through the servers of the system 10. The system 10 includes a user registration subsystem 30 operable by the one or more processors 20. The user registration subsystem 30 registers a user in the system 10 based on one or more details received from the user. In such embodiment, the one or more details may include, but not limited to, a mobile number, one or more verification methods, a name of the user and the like. In such embodiment, the one or more verification methods may include, but not limited to, a verification identity code, a verification message, a onetime password sent on a device associated with the mobile number of the user and the like.

Further, the user registration subsystem 30 also receives an input from the user representative of a plurality of rules defined by the user. In such embodiment, the plurality of rules may include, but not limited to, a selection of plurality of applications on the device of the user to be managed by the system 10, selection of a priority of the call from one or more individuals on the device of the user, one or more call controls and the like.

Further, the system 10 includes a network configuration subsystem 40 communicatively coupled to the user registration subsystem 30 and operable by the one or more processors 20. The network configuration subsystem 40 identifies an ongoing Internet Protocol call on the device of the user. In one specific embodiment, each device may include a port for mobility call and IP call and the network configuration subsystem may use ports for identifying the ongoing calls. In one embodiment, the network configuration subsystem 40 may also identify an ongoing mobility call. In one specific embodiment, the network configuration subsystem 40 may identify the ongoing IP call via a port in the device of the user. In such embodiment, the port may include an IP port on the deice of the user. In one embodiment, the network configuration subsystem 40 may identify a category of a call such as a mobility call or an IP call. The network configuration subsystem 40 also changes network configuration of an operator (network service provider) associated with the user in accordance with the plurality of the rules defined by the user and the call may be routed on the servers of the system 10, when the user is on the ongoing internet protocol call identified by the network configuration subsystem 40. In one exemplary embodiment, if the network configuration subsystem 40 identifies that the user is on an IP call, then the one or more mobility calls by the device associated with the user are routed to a predefined voice-based notification. In one embodiment, the voice-based notification may be defined by the user, the system, or the mobility call network operator of the user. In an exemplary embodiment, the voice-based notification may be invoked by the network operator or the system as the case may be. In another exemplary embodiment, the network configuration subsystem 40 may reject the one or more mobility calls in accordance with the plurality of rules defined by the user.

Further, the system 10 includes a notification subsystem 50 communicatively coupled to the network configuration subsystem 40 and operable by the one or more processors 20. The notification subsystem 50 notifies the user via one or more communication means in accordance with the plurality of rules defined by the user if there are one or more calls which are received by the user during the ongoing Internet Protocol call. In such embodiment, the one or more communication means may include, but not limited to, a message, an electronic mail, a short message service (SMS) and the like. The notification subsystem 50 also notifies a caller about the ongoing Internet Protocol call of the user via the one or more communication means. In another embodiment, the notification subsystem 50 may notify the user about one or more calls received during a period when the user was on another IP call or another mobility call.

Further, the network configuration subsystem 40 identifies whether the ongoing Internet Protocol call is disconnected. Moreover, the network configuration subsystem 40 changes the network configuration back to an original state of the network after the ongoing internet protocol is disconnected. In one embodiment, the user may be able to view a list of missed calls on the web application or the mobile application.

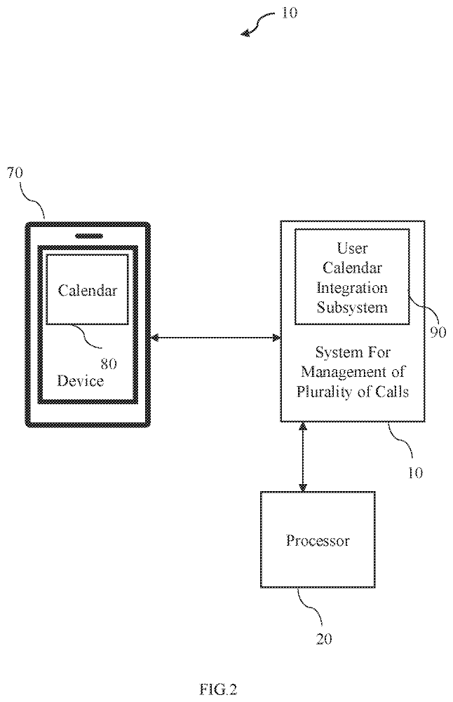

FIG. 2 is a block diagram representation of a calendar integration subsystem 90 of the system 10 for management of plurality of calls FIG. 1 in accordance with an embodiment of the present disclosure. The calendar integration subsystem 90 is operable by the one or more processors 20. The calendar integration subsystem 90 identifies one or more calls scheduled on a calendar 80 on the device 70 of the user. In an exemplary embodiment, the calendar integration subsystem 90 may be able to identify and classify the internet protocol calls and the mobility calls. In one embodiment, the calendar integration subsystem 90 may classify the internet protocol calls and the mobility calls using the data provided in the meeting invite available in the calendar. In one embodiment, the calendar integration subsystem 90 may receive an input from the user representative of giving an access to the calendar 80 of the device 70 of the user. In one specific embodiment, the user may be able to update the calendar 80 at any point of time. In another embodiment, the calendar integration subsystem 90 may verify with the user whether the user is joining the scheduled call as per given in the calendar 80 and request permissions from the user to manage the mobility calls during the scheduled call, in accordance with a response received by the user. In another embodiment, if the user is joining the scheduled call then the calendar integration subsystem 90 may initiate call routing to the predefined voice-based notification for a defined duration.

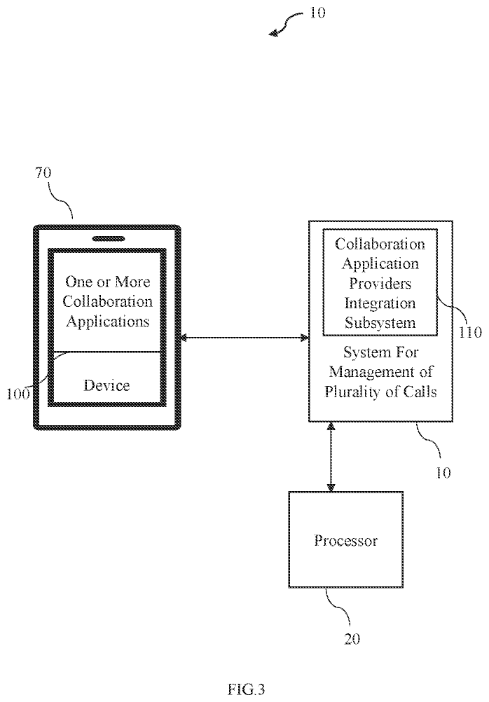

FIG. 3 is a block diagram representation of a collaboration application providers integration subsystem 110 of the system 10 for management of plurality of calls FIG. 1 in accordance with an embodiment of the present disclosure. The collaboration application providers integration subsystem 110 is operable by the one or more processors 20. The collaboration application providers (CAP) integration subsystem 110 integrates plurality of collaboration applications 100 on the device 70 selected by the user to the system 10 to perform one or more tasks. In one embodiment, the one or more collaboration applications providers may include one or more internet-based video calling services, one or more internet-based messaging services, one or more internet-based calling services and the like. In such embodiment, the one or more tasks may include, but not limited to, obtaining the mobile number of the user and linking the CAP associated with the user to the mobile number of the user, establish a communication link between the system 10 and the CAP, communicate information associated with the user to the system 10, autoroute the one or more calls whenever the one or more calls is received via the plurality of collaboration applications when the user is on an ongoing call and the like.

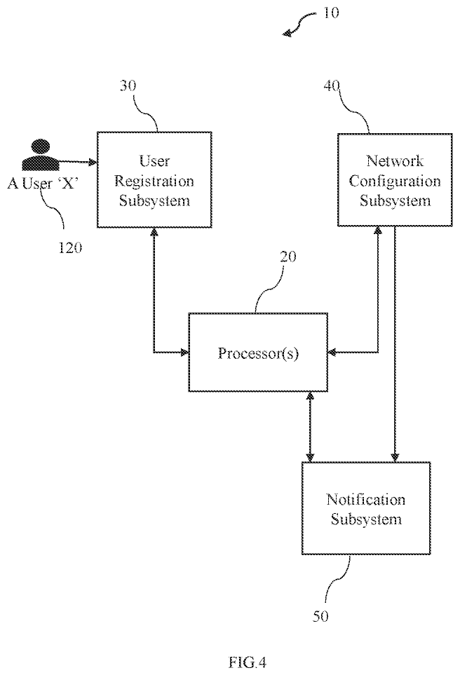

FIG. 4 is an exemplary embodiment representing a block diagram of the system 10 for management of plurality of calls FIG. 1 in accordance with an embodiment of the present disclosure. A user ‘X’ 120 registers in the system 10 based on the one or more details such as a mobile number of the user ‘X’ 120, an onetime password sent on a device associated with the mobile number of the user ‘X’ 120 and the like, by the registration subsystem 30. After receiving the one or more details, the user registration subsystem 30 receives an input from the user ‘X’ 120 representative of the plurality of rules such as a selection of plurality of applications to be managed by the system 10 and selection of a priority of the call from one or more individuals on the device of the user ‘X’ 120. After defining the plurality of rules by the user ‘X’ 120, if the user ‘X’ 120 is on an ongoing internet protocol call on the device of the user ‘X’ 120 then the network configuration subsystem 40 identifies the ongoing internet protocol call and changes the network configuration of the operator associated with the user ‘X’ 120 in accordance with the plurality of rules defined by the user ‘X’ 120 by the network configuration subsystem 40.

After identifying the user ‘X’ 120 on the ongoing internet protocol call, if the user ‘X’ 120 is receiving a call during the ongoing internet protocol call the user ‘X’ 120 will be notified via the one or more communication means in accordance with the plurality of rules defined by the user ‘X’ 120. Moreover, the caller will also be notified about the ongoing internet protocol call of the user ‘X’ 120 via the one or more communication means by the notification subsystem 50. Furthermore, the network configuration subsystem 40 will identify whether the ongoing internet protocol call of the user ‘X’ 120 is disconnected, when the ongoing internet protocol call is disconnected then the network configuration is changed back to the original state of the network by the network configuration subsystem 40.

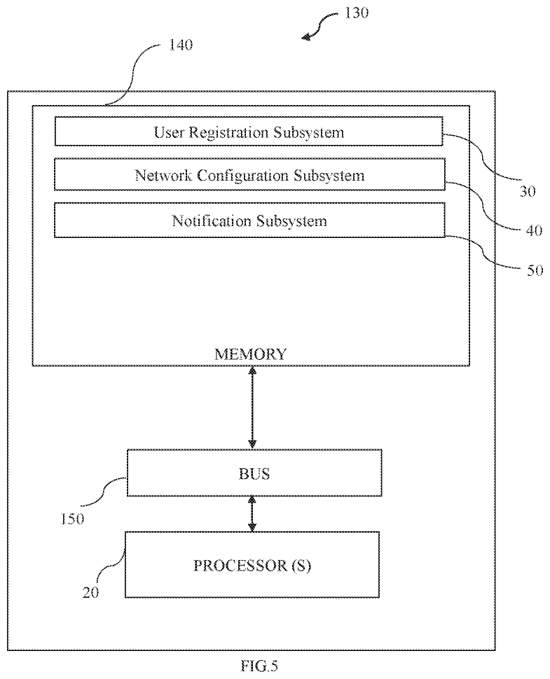

FIG. 5 is a block diagram of management computer system 130 or a server for plurality of calls in accordance with an embodiment of the present disclosure. The computer system 130 includes processor(s) 20, and memory 140 coupled to the processor(s) 20 via a bus 150. The memory 140 is stored locally on a seeker device.

The processor(s) 20, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 140 includes multiple units stored in the form of executable program which instructs the processor 20 to perform the configuration of the system illustrated in FIG. 2. The memory 140 has following subsystems: a user registration subsystem 30, a network configuration subsystem 40, and a notification subsystem 50 of FIG. 1.

Computer memory 140 elements may include any suitable memory device(s) for storing data and executable program, such as read-only memory, random access memory, erasable programmable read-only memory, electrically erasable programmable read-only memory, hard drive, removable media drive for handling memory cards and the like. Embodiments of the present subject matter may be implemented in conjunction with program subsystems, including functions, procedures, data structures, and application programs, for performing tasks, or defining abstract data types or low-level hardware contexts. The executable program stored on any of the above-mentioned storage media may be executable by the processor(s) 20.

The user registration subsystem 30 instructs the processor(s) 20 to register a user in the system based on one or more details received from the user. The user registration subsystem 30 also instructs the processor(s) 20 to receive an input from the user representative of a plurality of rules defined by the user. The network configuration subsystem 40 instructs the processor(s) 20 to identify an ongoing Internet Protocol call on the device of the user. The network configuration subsystem 40 also instructs the processor(s) 20 to change network configuration of an operator associated with the user in accordance with the plurality of the rules defined by the user. The notification subsystem 50 instructs the processor(s) 20 to notify the user via one or more communication means in accordance with the plurality of rules defined by the user if there are one or more calls which are received by the user during the ongoing Internet Protocol call. The notification subsystem 50 also instructs the processor(s) 20 to notify a caller about the ongoing Internet Protocol call of the user via the one or more communication means. The network configuration subsystem 40 instructs the processor(s) 20 to identify whether the ongoing Internet Protocol call is disconnected. The network configuration subsystem 40 also instructs the processor(s) 20 to change the network configuration back to an original state of the network after the ongoing internet protocol is disconnected.

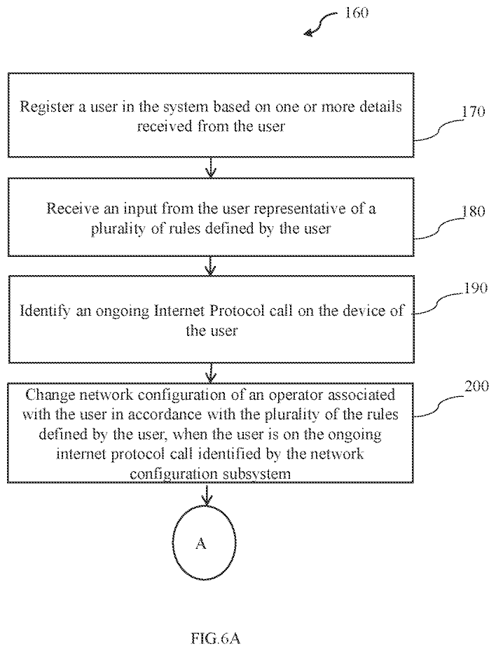

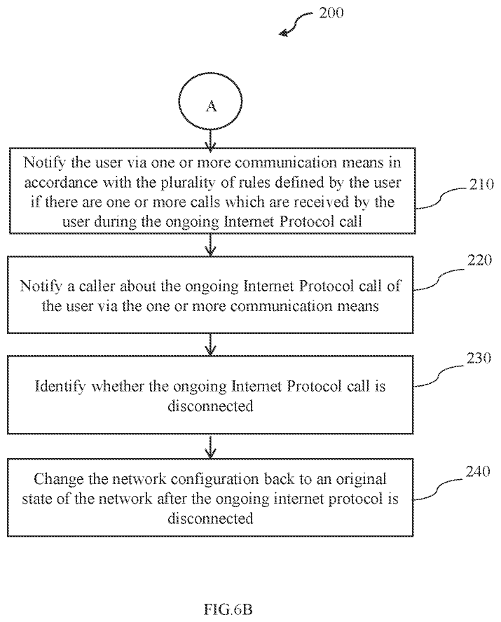

FIG. 6A and FIG. 6B are flow diagrams representing steps involved in a method 160 for management of plurality of calls in accordance with an embodiment of the present disclosure. In one embodiment, managing the plurality of calls may include managing one or more internet protocol (IP) calls, and one or more mobility calls. The method 160 includes registering, by a user registration subsystem, a user in the system based on one or more details received from the user in step 170. In such embodiment, registering based on the one or more details may include registering based on a onetime password sent on a device associated with the mobile number of the user, a name of the user and the like.

Further, the method 160 includes receiving, by the user registration subsystem, an input from the user representative of a plurality of rules defined by the user in step 180. In such embodiment, receiving the plurality of rules may include receiving a selection of plurality of applications on the device of the user to be managed by the system, selection of a priority of the call from one or more individuals on the device of the user, one or more call controls and the like.

Further, the method 160 includes identifying, by a network configuration subsystem, an ongoing Internet Protocol call on the device of the user in step 190. In one embodiment, the method 160 may include identifying an ongoing mobility call. In one specific embodiment, the method 160 may include identifying the ongoing IP call from an independent data connectivity and the device associated with the user. In one embodiment, the method 160 may include identifying a category of a call such as a mobility call or an IP call. The method 160 includes changing, by the network configuration subsystem, network configuration of an operator associated with the user in accordance with the plurality of the rules defined by the user, when the user is on the ongoing internet protocol call identified by the network configuration subsystem in step 200.

Further, the method 160 includes notifying, by a notification subsystem, the user via one or more communication means in accordance with the plurality of rules defined by the user if there are one or more calls which are received by the user during the ongoing Internet Protocol call in step 210. In such embodiment, notifying via the one or more communication means may include notifying via a message, an electronic mail and the like. The method 160 also includes notifying, by the notification subsystem, a caller about the ongoing Internet Protocol call of the user via the one or more communication means in step 220. In one particular embodiment, the method 160 may include notifying the caller that the user is on some call via the one or more communication means. In another embodiment, the method 160 may include notifying the user about one or more calls received during a period when the user was on another IP call or another mobility call.

Further, the method 160 includes identifying, by the network configuration subsystem, whether the ongoing Internet Protocol call is disconnected in step 230. Moreover, the method 160 also includes changing, by the network configuration subsystem, the network configuration back to an original state of the network after the ongoing internet protocol is disconnected in step 240. In one embodiment, the method 160 may include viewing a list of missed calls on the web application or the mobile application.

Various embodiments of the present disclosure provide a technical solution to the problem for management of plurality of calls. The present system seamlessly manages the plurality of calls, such as internet protocol calls, mobility calls and the like, by providing an appropriate response to the caller as well as the called party. In comparison to conventional call management systems, the current system provides improved call management at a system and network level. The current system improves response generation and response transmission to the caller as the response in now predefined and not provided by the system on a temporary basis as provided by the user for each call. Also, the current system prevents IP call intrusion by the mobility call when received during the IP call. Moreover, the processing requirements and response time of the current system is reduced in comparison to the conventional systems as the steps to be executed by the current system are lesser due to better standardization of the permissions provided by the user. Also, the system is capable of being implemented on the network service provider level or at the device level or a combination thereof, which improves flexibility in operation of the system in comparison to the conventional systems.

Moreover, the current solution integrates the system with the calendar on the device of the user to identify scheduled calls for the user and takes input from the user on whether the user wants the system to manage the mobility calls during the scheduled call, which makes the system user-friendly and saves efforts of the user to constantly manage the mobility calls during the scheduled calls. Furthermore, the current system provides the user to select one or more application from the device of the user which the user wants the system to manage and automate the one or more calls, which saves the effort and time of the user does not have to keep a check on the one or more applications continuously.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for management of plurality of calls hosted on a server comprising:
a user registration subsystem operable by the one or more processors, wherein the user registration subsystem is configured to:
register a user in the system based on one or more details received from the user, wherein the one or more details comprise a mobile number, a onetime password sent on a device associated with the mobile number of the user and a name of the user;
receive an input from the user representative of a plurality of rules defined by the user, wherein two of the plurality of rules comprise a selection of plurality of applications to be managed by the system and selection of a priority of the call from one or more individuals on the device of the user;
a network configuration subsystem operable by the one or more processors, wherein the network configuration subsystem is configured to:
identify an ongoing Internet Protocol call on the device of the user;
change network configuration of an operator associated with the user in accordance with the plurality of the rules defined by the user, when the user is on the ongoing internet protocol call identified by the network configuration subsystem;
identify whether the ongoing Internet Protocol call is disconnected;
change the network configuration back to an original state of the network after the ongoing internet protocol is disconnected;
a notification subsystem communicatively coupled to the network configuration subsystem and operable by the one or more processors, wherein the notification subsystem is configured to:
notify the user via one or more communication means in accordance with the plurality of rules defined by the user if there are one or more calls which are received by the user during the ongoing Internet Protocol call, and
notify a caller about the ongoing Internet Protocol call of the user via the one or more communication means.

2. The system as claimed in claim 1, wherein the one or more communication means comprise a message, a short message service and an electronic mail.

3. The system as claimed in claim 1, comprising a user calendar integration subsystem operable by the one or more processors, wherein the user calendar integration subsystem is configured to identify one or more internet protocol calls scheduled on a calendar on the device of the user to manage one or more incoming calls during the scheduled internet protocol calls.

4. The system as claimed in claim 1, comprising a collaboration application providers integration subsystem operable by the one or more processors, wherein the collaboration application providers integration subsystem is configured to integrate plurality of collaboration applications on the device selected by the user to the system to perform one or more tasks.

5. The system as claimed in claim 3, wherein the one or more tasks comprise taking a mobile number linked to the CAP associated with the user, establish a communication link between the system and the CAP, communicate information associated with the user to the system and autoroute the one or more calls whenever the one or more calls is received via the plurality of collaboration applications.

6. A method for management of plurality of calls, the method comprising:
registering, by a user registration subsystem, a user in the system based on one or more details received from the user, wherein the one or more details comprise a mobile number, a onetime password sent on a device associated with the mobile number of the user and a name of the user;
receiving, by the user registration subsystem, an input from the user representative of a plurality of rules defined by the user, wherein two of the plurality of rules comprise a selection of plurality of applications to be managed by the system and selection of a priority of the call from one or more individuals on the device of the user;
identifying, by a network configuration subsystem, an ongoing Internet Protocol call on the device of the user;
changing, by the network configuration subsystem, network configuration of an operator associated with the user in accordance with the plurality of the rules defined by the user, when the user is on the ongoing internet protocol call identified by the network configuration subsystem;
notifying, by a notification subsystem, the user via one or more communication means in accordance with the plurality of rules defined by the user if there are one or more calls which are received by the user during the ongoing Internet Protocol call;
notifying, by the notification subsystem, a caller about the ongoing Internet Protocol call of the user via the one or more communication means;
identifying, by the network configuration subsystem, whether the ongoing Internet Protocol call is disconnected; and
changing, by the network configuration subsystem, the network configuration back to an original state of the network after the ongoing internet protocol is disconnected.

7. The method as claimed in claim 6, comprising notifying via the one or more communication means, wherein the one or more communication means comprise a message, a short message service and an electronic mail.

8. The method as claimed in claim 6, comprising identifying, by a user calendar integration subsystem, one or more calls scheduled on a calendar on the device of the user to manage one or more incoming calls during the scheduled internet protocol calls.

9. The method as claimed in claim 6, comprising integrating, by a collaboration application provider integration subsystem, plurality of collaboration applications on the device selected by the user to the system to perform one or more tasks.

10. The method as claimed in claim 9, comprising performing the one or more tasks, wherein the one or more tasks comprise taking a mobile number linked to the CAP associated with the user, establish a communication link between the system and the CAP, communicate information associated with the user to the system and autoroute the one or more calls whenever the one or more calls is received via the plurality of collaboration applications.
